(19) United States
(12) Patent Application Publication
(10) Pub. No.: US 2022/0203602 A1
(43) Pub. Date: Jun. 30, 2022

(54) METHOD OF MANUFACTURING HANDRAIL ASSEMBLY, HANDRAIL ASSEMBLY, SUPPORT FRAME STRUCTURE, AND CHILD CARRIAGE

(71) Applicant: WONDERLAND SWITZERLAND AG, Steinhausen (CH)

(72) Inventor: Bo WU, Dongguan (CN)

(21) Appl. No.: 17/562,617

(22) Filed: Dec. 27, 2021

(30) Foreign Application Priority Data
Dec. 28, 2020 (CN) 202011585042.8

(51) Int. Cl. B29C 63/00; B62B 9/20; B29C 63/06; B29C 63/48

(52) U.S. Cl. CPC B29C 63/0069; B62B 9/20; B29C 63/0017; B29C 63/06; B29L 2031/3029; B62B 2501/04; B62B 2501/065; B29C 2063/485; B29C 63/48

(57) ABSTRACT

The invention discloses a method of manufacturing a handrail assembly including steps of 1) providing a first material layer and a second material layer, wherein the second material layer is a hot melt material; 2) stacking the second material layer on the first material layer to form a substrate layer with an integrated structure; 3) curling the substrate layer to form a handrail cover matching a handrail tube, wherein the handrail cover is a sleeve structure and the second material layer is located at an inner side of the handrail cover; 4) inserting the handrail tube matching the handrail cover into the handrail cover to form a handrail assembly semi-finished product; 5) baking the handrail assembly semi-finished product until the second material layer is completely melted; and 6) cooling the handrail assembly semi-finished product after baking to form the handrail assembly.

### BACKGROUND OF THE INVENTION

### 1. Field of the Invention

The invention relates to a baby product and, more particularly, to a method of manufacturing a handrail assembly, a handrail assembly, a support frame structure and a child carriage with the handrail assembly.

### 2. Description of the Prior Art

The design of a child carriage always considers the safety of child seated therein. Therefore, the child carriage is usually equipped with a front handrail extending forward to prevent the child from falling forward. In general, the front handrail is covered by a handrail cover. At present, the conventional handrail cover of a stroller mostly utilizes an adhesive layer to adhere Ethylene-Vinyl Acetate (EVA) to the back of leather. Then, a layer of glue is uniformly coated on a surface of a handrail tube and the handrail cover is assembled to the handrail tube of the stroller. It takes a long time to wait for the glue to solidify before the handrail cover can be fixedly adhered to the handrail tube. The aforesaid process is complicated and one single person can only process one handrail assembly at a time, thereby consuming labor and man-hours. Furthermore, the handrail cover cannot be attached to the handrail tube well after assembly, i.e. the handrail cover is not attached to the handrail tube tightly. Thus, some uneven wrinkles may appear, such that the overall appearance of the handrail assembly and the child carriage will be greatly affected.

Therefore, it is necessary to provide a method of manufacturing a handrail assembly, which is capable of processing a plurality of handrail assemblies at a time, and the handrail cover can be attached to the handrail tube tightly after assembly, thereby simplifying operation of process, reducing process, saving labor cost, and greatly improving manufacturing efficiency.

### SUMMARY OF THE INVENTION

An objective of the invention is to provide a method of manufacturing a handrail assembly, which is capable of processing a plurality of handrail assemblies at a time, and the handrail cover can be attached to the handrail tube tightly after assembly, thereby simplifying operation of process, reducing process, saving labor cost, and greatly improving manufacturing efficiency.

Another objective of the invention is to provide a handrail assembly manufactured according to the aforesaid method and the handrail cover can be attached to the handrail tube tightly after assembly, thereby simplifying operation of process, reducing process, saving labor cost, and greatly improving manufacturing efficiency.

Another objective of the invention is to provide a support frame structure with a handrail assembly manufactured according to the aforesaid method and the handrail cover can be attached to the handrail tube tightly after assembly, thereby simplifying operation of process, reducing process, saving labor cost, and greatly improving manufacturing efficiency.

Another objective of the invention is to provide a child carriage with the aforesaid support frame structure and the handrail cover can be attached to the handrail tube tightly after assembly, thereby simplifying operation of process, reducing process, saving labor cost, and greatly improving manufacturing efficiency.

To achieve the aforesaid objectives, the invention provides a method of manufacturing a handrail assembly comprising steps of:

1) providing a first material layer and a second material layer, wherein the second material layer is a hot melt material;

2) stacking the second material layer on the first material layer to form a substrate layer with an integrated structure;

3) curling the substrate layer to form a handrail cover matching a handrail tube, wherein the handrail cover is a sleeve structure and the second material layer is located at an inner side of the handrail cover;

4) inserting the handrail tube matching the handrail cover into the handrail cover to form a handrail assembly semi-finished product;

5) baking the handrail assembly semi-finished product until the second material layer is completely melted; and

6) cooling the handrail assembly semi-finished product after baking to form the handrail assembly.

Compared to the prior art, since the handrail cover of the invention is sleeved on the surface of the handrail tube and then baked at a high temperature, the second material layer is melted at the high temperature to fixedly attach the first material layer to the handrail tube. The handrail cover is tightly attached to the handrail tube after assembly and kept at a fixed position. The method of manufacturing the handrail assembly of the invention can process a plurality of handrail assemblies at a time, thereby simplifying operation of process, reducing process, saving labor cost, and greatly improving manufacturing efficiency.

Preferably, the step 2) further comprises steps of 21) adhering a side of a double-sided adhesive layer to the first material layer; and 22) adhering another side of the double-sided adhesive layer to the second material layer, wherein the second material layer and the first material layer form the substrate layer with the integrated structure by the double-sided adhesive layer.

Preferably, the step 3) further comprises step of curling and stitching the substrate layer to form the handrail cover matching the handrail tube.

Preferably, the first material layer is a flexible structure.

Preferably, the first material layer is selected from one of leather layer, soft rubber layer and foam layer.

Preferably, the second material layer is a film structure.

Preferably, the second material layer is selected from one of PU hot melt adhesive film, TPU hot melt adhesive film, PS hot melt adhesive film and PA hot melt adhesive film.

Preferably, a baking temperature of the step 5) is between 100° C. and 150° C. Preferably, the baking temperature is 130° C.

Preferably, a baking time of the step 5) is between 2 minutes and 6 minutes. Preferably, the baking time is 3 minutes.

A handrail assembly provided by the invention is manufactured according to the aforesaid method of manufacturing the handrail assembly, wherein the handrail assembly comprises a handrail tube and a handrail cover sleeved on the handrail tube. The handrail cover comprises a first material layer and a second material layer stacked with each other. The handrail cover is an integrated structure. The handrail cover is fixed on the handrail tube by the second material layer.

A support frame structure provided by the invention comprises a front support frame assembly, a rear support frame assembly, a handle assembly, a connecting assembly configured to connect the front support frame assembly, the rear support frame assembly and the handle assembly, and the aforesaid handrail assembly. The handrail assembly is detachably connected with the connecting assembly.

Preferably, the support frame structure is a stroller structure, a crib structure or a baby seat structure.

A child carriage provided by the invention comprises a carriage body and the aforesaid support frame structure configured to support the carriage body.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating the structure of a child carriage of the invention.

FIG. 2 is a schematic view illustrating the structure of a handrail assembly of the invention.

FIG. 3 is a schematic sectional view illustrating the structure of the handrail assembly of the invention.

FIG. 4 is a schematic sectional view illustrating the structure of the handrail assembly of another embodiment of the invention.

### DETAILED DESCRIPTION

In order to explain the disclosure and structural features in detail, the invention will be further described with the embodiments and drawings in the following.

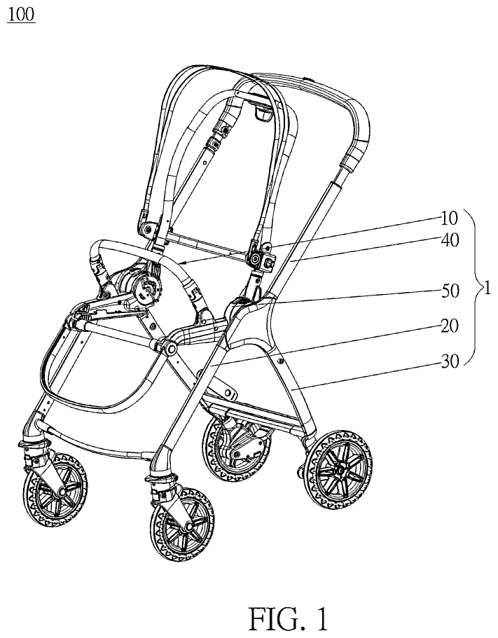

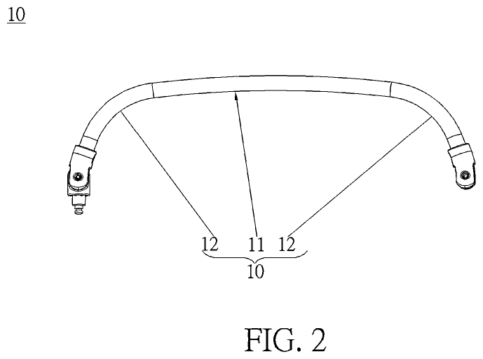

As shown in FIGS. 1 to 4, a child carriage 100 of the invention comprises a carriage body and a support frame structure 1 configured to support the carriage body. The child carriage 100 is exemplified by a stroller for illustration purpose, but the invention is not so limited. The child carriage 100 may also be a crib, a baby seat, and so on. The support frame structure 1 of the stroller of the invention comprises a handrail assembly 10, a front support frame assembly 20, a rear support frame assembly 30, a handle assembly 40, and a connecting assembly 50 configured to connect the front support frame assembly 20, the rear support frame assembly 30 and the handle assembly 40. The handrail assembly 10 comprises a handrail tube 12 and a handrail cover 11 sleeved on the handrail tube 12. The handrail cover 11 comprises a first material layer 111 and a second material layer 113 stacked with each other. The handrail cover 11 is an integrated structure. The handrail cover 11 is fixed on the handrail tube 12 by the second material layer 113.

### First Embodiment

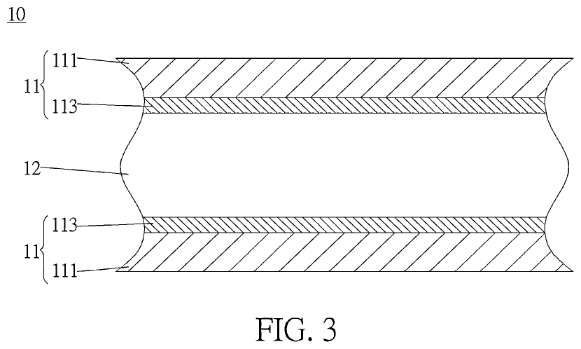

As shown in FIG. 3, a method of manufacturing the handrail assembly 10 comprises steps of:

1) providing a first material layer 111 and a second material layer 113, wherein the second material layer 113 is a hot melt material;

2) stacking the second material layer 113 on the first material layer 111 to form a substrate layer with an integrated structure;

3) curling the substrate layer to form a handrail cover 11 matching a handrail tube 12, wherein the handrail cover 11 is a sleeve structure and the second material layer 113 is located at an inner side of the handrail cover 11;

4) inserting the handrail tube 12 matching the handrail cover 11 into the handrail cover 11 to form a handrail assembly semi-finished product;

5) baking the handrail assembly semi-finished product at a temperature of 130° C. for 3 minutes until the second material layer 113 is completely melted; and

6) cooling the handrail assembly semi-finished product after baking to form the handrail assembly 10.

Specifically, the first material layer 111 is a flexible structure.

More specifically, the first material layer 111 may be, but not limited to, leather layer. The first material layer 111 may also be soft rubber layer or foam layer.

Specifically, the second material layer 113 is a film structure.

More specifically, the second material layer 113 may be, but not limited to, polyurethane (PU) hot melt adhesive film. The second material layer 113 may also be one of thermoplastic polyurethanes (TPU) hot melt adhesive film, polystyrene (PS) hot melt adhesive film and polyamide (PA) hot melt adhesive film. Other hot melt adhesive films capable of adhering the second material layer 113 to the first material layer 111 are all within the scope of the invention.

As shown in FIG. 3, the second material layer 113 may be stacked and fixed on the first material layer 111 by hot pressing or vacuum adsorption.

### Second Embodiment

As shown in FIG. 3, a method of manufacturing the handrail assembly 10 comprises steps of:

1) providing a first material layer 111 and a second material layer 113, wherein the second material layer 113 is a hot melt material;

2) stacking the second material layer 113 on the first material layer 111 to form a substrate layer with an integrated structure;

3) curling and stitching the substrate layer to form a handrail cover 11 matching a handrail tube 12, wherein the handrail cover 11 is a sleeve structure and the second material layer 113 is located at an inner side of the handrail cover 11;

4) inserting the handrail tube 12 matching the handrail cover 11 into the handrail cover 11 to form a handrail assembly semi-finished product;

5) baking the handrail assembly semi-finished product at a temperature of 130° C. for 3 minutes until the second material layer 113 is completely melted; and

6) cooling the handrail assembly semi-finished product after baking to form the handrail assembly 10.

Specifically, the first material layer 111 is a flexible structure.

More specifically, the first material layer 111 may be, but not limited to, leather layer. The first material layer 111 may also be soft rubber layer or foam layer.

Specifically, the second material layer 113 is a film structure.

More specifically, the second material layer 113 may be, but not limited to, PU hot melt adhesive film. The second material layer 113 may also be one of TPU hot melt adhesive film, PS hot melt adhesive film and PA hot melt adhesive film.

As shown in FIG. 3, the second material layer 113 may be stacked and fixed on the first material layer 111 by hot pressing or vacuum adsorption. Other manners capable of stacking and fixing the second material layer 113 on the first material layer 111 are all within the scope of the invention.

### Third Embodiment

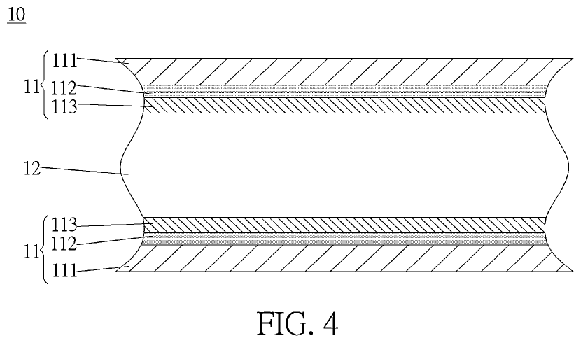

As shown in FIG. 4, a method of manufacturing the handrail assembly 10 comprises steps of:

1) providing a first material layer 111 and a second material layer 113, wherein the second material layer 113 is a hot melt material;

2) adhering a side of a double-sided adhesive layer 112 to the first material layer 111 and adhering another side of the double-sided adhesive layer 112 to the second material layer 113, wherein the second material layer 113 and the first material layer 111 form a substrate layer with an integrated structure by the double-sided adhesive layer 112;

3) curling the substrate layer to form a handrail cover 11 matching a handrail tube 12, wherein the handrail cover 11 is a sleeve structure and the second material layer 113 is located at an inner side of the handrail cover 11;

4) inserting the handrail tube 12 matching the handrail cover 11 into the handrail cover 11 to form a handrail assembly semi-finished product;

5) baking the handrail assembly semi-finished product at a temperature of 130° C. for 3 minutes until the second material layer 113 is completely melted; and

6) cooling the handrail assembly semi-finished product after baking to form the handrail assembly 10.

Specifically, the first material layer 111 is a flexible structure.

More specifically, the first material layer 111 may be, but not limited to, leather layer. The first material layer 111 may also be soft rubber layer or foam layer.

Specifically, the second material layer 113 is a film structure.

More specifically, the second material layer 113 may be, but not limited to, PU hot melt adhesive film. The second material layer 113 may also be one of TPU hot melt adhesive film, PS hot melt adhesive film and PA hot melt adhesive film.

Specifically, in the step 2), the invention uses the double-sided adhesive layer 112 to adhere the second material layer 113 to the first material layer 111, but the adhesive manner is not limited to the double-sided adhesive. Other adhesive manners capable of adhering the second material layer 113 to the first material layer 111 are all within the scope of the invention.

As shown in FIGS. 1 to 4, since the handrail cover 11 of the invention is sleeved on the surface of the handrail tube 12 and then baked at a high temperature, the second material layer 113 is melted at the high temperature to fixedly attach the first material layer 111 to the handrail tube 12. The handrail cover 11 is tightly attached to the handrail tube 12 after assembly and kept at a fixed position. The method of manufacturing the handrail assembly 10 of the invention can process a plurality of handrail assemblies 10 at a time, thereby simplifying operation of process, reducing process, saving labor cost, and greatly improving manufacturing efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of manufacturing a handrail assembly comprising steps of:
1) providing a first material layer and a second material layer, wherein the second material layer is a hot melt material;
2) stacking the second material layer on the first material layer to form a substrate layer with an integrated structure;
3) curling the substrate layer to form a handrail cover matching a handrail tube, wherein the handrail cover is a sleeve structure and the second material layer is located at an inner side of the handrail cover;
4) inserting the handrail tube matching the handrail cover into the handrail cover to form a handrail assembly semi-finished product;
5) baking the handrail assembly semi-finished product until the second material layer is completely melted; and
6) cooling the handrail assembly semi-finished product after baking to form the handrail assembly.

2. The method of claim 1, wherein the step 2) further comprises steps of:
21) adhering a side of a double-sided adhesive layer to the first material layer; and
22) adhering another side of the double-sided adhesive layer to the second material layer, wherein the second material layer and the first material layer form the substrate layer with the integrated structure by the double-sided adhesive layer.

3. The method of claim 1, wherein the step 3) further comprises step of:
curling and stitching the substrate layer to form the handrail cover matching the handrail tube.

4. The method of claim 1, wherein the first material layer is a flexible structure.

5. The method of claim 4, wherein the first material layer is selected from one of leather layer, soft rubber layer and foam layer.

6. The method of claim 1, wherein the second material layer is a film structure.

7. The method of claim 6, wherein the second material layer is selected from one of PU hot melt adhesive film, TPU hot melt adhesive film, PS hot melt adhesive film and PA hot melt adhesive film.

8. The method of claim 1, wherein a baking temperature of the step 5) is between 100° C. and 150° C.

9. The method of claim 1, wherein a baking time of the step 5) is between 2 minutes and 6 minutes.

10. A handrail assembly manufactured according to the method of claim 1, the handrail assembly comprising a handrail tube and a handrail cover sleeved on the handrail tube, the handrail cover comprising a first material layer and a second material layer stacked with each other, the handrail cover being an integrated structure, the handrail cover being fixed on the handrail tube by the second material layer.

11. A support frame structure comprising a front support frame assembly, a rear support frame assembly, a handle assembly, a connecting assembly configured to connect the front support frame assembly, the rear support frame assembly and the handle assembly, and the handrail assembly of claim 10, the handrail assembly being detachably connected with the connecting assembly.

12. The support frame structure of claim 11, wherein the support frame structure is a stroller structure, a crib structure or a baby seat structure.

13. A child carriage comprising a carriage body and the support frame structure of claim 12 configured to support the carriage body.
